(19) United States
(12) Patent Application Publication
(10) Pub. No.: US 2004/0040213 A1
(43) Pub. Date: Mar. 4, 2004

(54) Controlled counter balance actuator for a lift-gate

(76) Inventors: Ann McCarthy-Garland, Harper Woods, MI (US); Ronald J. Wilde, St Clair Shores, MI (US)

Correspondence Address: DELPHI TECHNOLOGIES, INC., M/C 480-410-202, PO BOX 5052, TROY, MI, 48007, US

(21) Appl. No.: 10/230,560

(22) Filed: Aug. 29, 2002

(51) Int. Cl. E05F 11/24

(52) U.S. Cl. 49/341

(57) ABSTRACT

A controlled counter-balance actuator opens and closes a lift-gate of a sport utility vehicle. The controlled counter-balance actuator includes a drive unit at each side of the lift-gate having a rotor that is pivotally secured to a body of the vehicle in a fixed position and a gas spring. The gas spring is pivotally secured to the rotor at one end and pivotally secured to the lift-gate at the opposite end. The rotor is indexed angularly by an electric motor so as to rotate from a home position to an open position in one direction or to a close position in an opposite direction. The rotor and the gas spring hold the lift-gate in an open position or a close position when the rotor is in the home position, move an open lift-gate toward the closed position when the rotor is indexed from the home position to the close position, and move a closed the lift-gate toward an open position when the rotor is indexed from the home position to the open position.

### FIELD OF THE INVENTION

This invention relates to an actuator for a lift-gate and more particularly to a counter balance actuator for a lift-gate.

### BACKGROUND OF THE INVENTION

Sport utility vehicles and minivans are popular vehicles today. These vehicles include large cargo areas that are accessible via a large opening at the rear of the vehicle. The large opening is usually closed by a lift-gate that is hinged to the rear end of the vehicle roof so as to swing between a generally horizontal open position and a generally vertical closed position.

It is conventional to provide such a lift-gate with a counterbalance system comprising gas springs, that are sometimes called pneumatic struts. The gas springs are pivotally attached to the lift-gate at one end and pivotally attached to the vehicle body at the other end. These gas springs hold the lift-gate in the open position and store energy when the lift-gate is closed in order to assist in the subsequent opening of the lift-gate. A long standing problem with such a counterbalance system is that the moment arm of the gas spring changes substantially as the lift-gate moves from the open position to the closed position due to the geometry of the system. In fact, the change is so great, the counterbalance system is normally designed so that the gas springs go “over-center” near the end of their closing stroke so that the gas springs urge the lift-gate toward the closed position.

This changing moment arm means that considerable manual effort is needed to overcome the “over center” condition and lift the lift-gate to a position where the gas springs produce enough torque to assist in opening the lift-gate and then hold the lift-gate in the open position. The manual opening effort can be reduced by using stronger gas springs. However, it then becomes difficult to close the lift-gate against the resistance of the stronger gas springs. Consequently, various power lift-gate systems have been proposed to assist in the opening and/or closing of the lift-gate. See for instance, U.S. Pat. No. 5,896,703 granted to Kevin W. Wright et al Apr. 27, 1999 for a power lift-gate cable drive and U.S. Pat. No. 6,142,551 granted to Michael Ciavaglia et al Nov. 7, 2000 for a vehicle lift-gate power operating system.

Another proposed solution to the problem is disclosed in the U.S. Pat. No. 6,202,350 granted to Kyle Montgomery et al Mar. 20, 2001 for a power lift device. This patent discloses a lift-gate self closing device in which the lower ends of the gas springs (pneumatic struts) have plates that are pivotally connected to the vehicle body. These plates are rotated in one direction to open the lift-gate via the gas springs and rotated in the opposite direction to close the lift-gate via the gas springs. However, this proposed solution does not deal with the fundamental problem of the changing moment arm of the gas springs as the lift-gate travels between the open position and the closed position.

### SUMMARY OF THE INVENTION

This invention provides a controlled counter-balance actuator for opening and closing a lift-gate of a sport utility vehicle that deals with the problem of the changing moment arm of the gas springs as the lift-gate travels back and forth between the open and the closed positions. The controlled counter-balance actuator includes a drive unit at each side of the lift-gate having a rotor that is pivotally secured to a body of the vehicle in a fixed position and a gas spring. The gas spring is pivotally secured to the rotor at one end and pivotally secured to the lift-gate at the opposite end. The rotor is indexed angularly by an electric motor so as to rotate from a home position to an open position in one direction or to a close position in an opposite direction. The rotor and the gas spring hold the lift-gate in an open position or a close position when the rotor is in the home position, move an open lift-gate toward the closed position when the rotor is indexed from the home position to the close position, and move a closed the lift-gate toward an open position when the rotor is indexed from the home position to the open position.

### BRIEF DESCRIPTION OF THE DRAWINGS

FIG. 1 is a perspective view of a rear portion of a sport utility vehicle having a lift-gate, shown in the open position, and a controlled counterbalance actuator of the invention;

FIG. 2 is a side view of the rear portion of the sport utility vehicle of FIG. 1; and

FIG. 3 is a side view of the rear position of the sport utility vehicle of FIGS. 1 and 2 with the lift-gate shown in the closed position.

### DETAILED DESCRIPTION OF PREFERRED EMBODIMENT

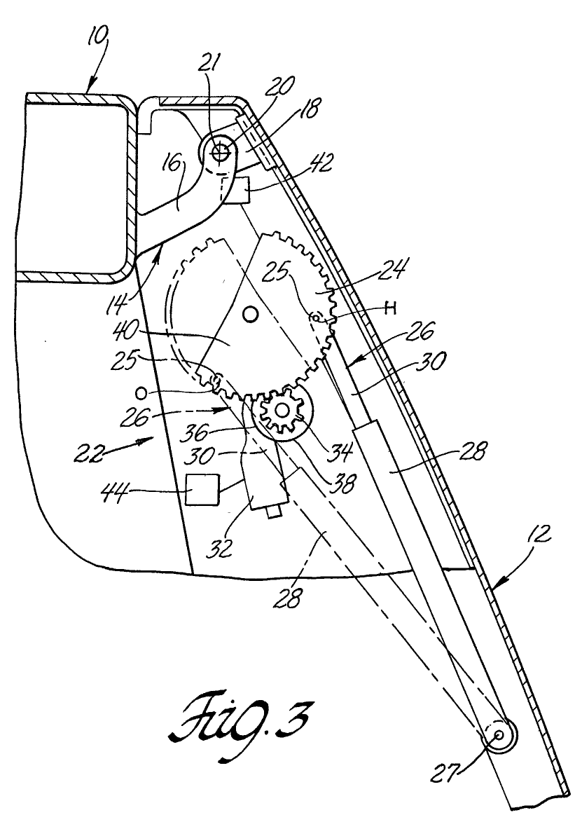

Referring now to the drawings, vehicle 10 has a lift-gate 12 that is attached to the aft end of the vehicle roof by two hinge assemblies. The typical right hand hinge assembly 14 is shown in FIGS. 2 and 3.

Hinge assemblies 14 have hinge portions 16 that are secured to a roof channel of the vehicle 10 and hinge portions 18 that are secured to lift-gate 12. Hinge portions 18 are attached to hinge portions 16 by pivot pins 20 so that lift-gate 12 pivots about a hinge axis indicated at 21 in FIGS. 2 and 3 from a raised open position shown in FIG. 2 to a closed position shown in FIG. 3. Pivot axis 21 is substantially horizontal and lift-gate 12 is generally permitted to pivot about 90° about hinge axis 21. However, the range of movement can be varied substantially from one vehicle 10 to another.

Lift-gate 12 is opened and closed by a controlled counter-balance actuator that includes two identical drive units 22 that are installed in the respective generally vertical pillars 23 at the aft end of the sport utility vehicle 10 that define the rear opening that is closed by lift-gate 12. The typical drive unit 22 is shown in FIGS. 2 and 3.

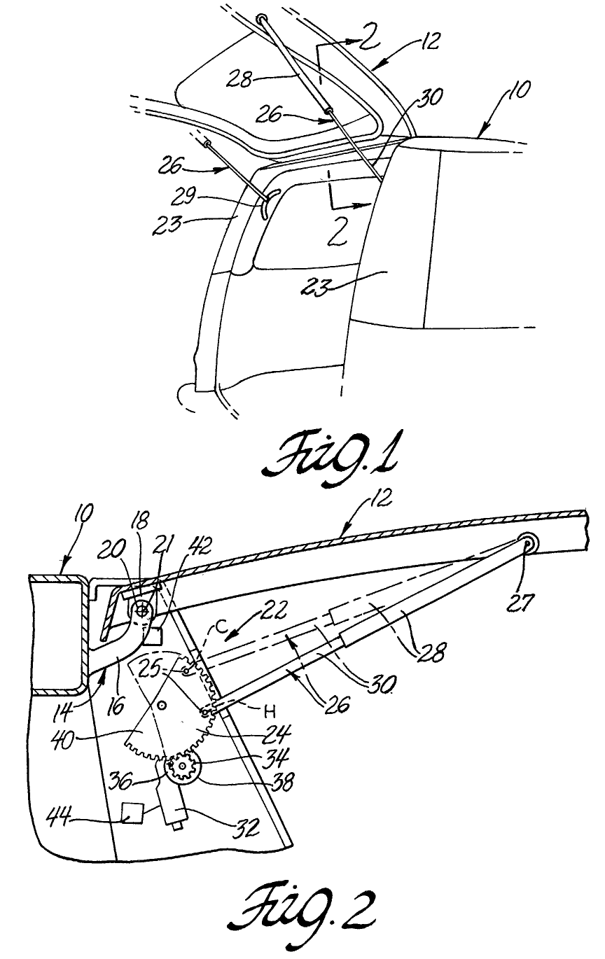

Each drive unit 22 comprises a rotor 24 that is pivotally secured to the vehicle body in a fixed position and a gas spring 26 that is pivotally secured to the rotor 24 by a pivot pin 25 at one end and pivotally secured to the lift-gate 12 by a pivot pin 27 at the opposite end. Each drive unit 22 is typically mounted beneath the sheet metal or other cover of the associated pillar 23. The gas spring 26 is typically outside the pillar cover with the pivot pin 25 extending through a slot 29 in the pillar cover to connect the gas spring 26 to the rotor 24 as best shown in FIG. 1. The typical gas spring 26 comprises a cylinder 28 and a plunger or rod 30 that is pushed into the cylinder to store energy by pressuring gas trapped in the cylinder 28. The pressurized gas then pushes the rod 30 out of the cylinder 28 when the end of the rod 30 is released. The gas spring is shown with the end of the cylinder 28 pivotally secured to the lift-gate 12 and the end of the rod 30 pivotally secured to the rotor 24. However, the gas spring 26 can be reversed with the rod 30 pivotally secured to lift-gate 12 and the cylinder 28 pivotally secured to rotor 24.

Rotor 24 is indexable angularly so as to rotate counterclockwise from a home position “H” position to a close position “C” (shown in phantom in FIG. 2) and from the home position “H” clockwise to an open position “O” (shown in phantom is FIG. 3). The home position “H”, close position “C” and open position “O” are marked at the pivot 25 in FIGS. 2 and 3.

Rotor 24 is indexed by a reversible electric motor 32 that drives a pinion gear 34 via a reduction gear unit 36. An electromagnetic clutch 38 is preferably interposed between reduction gear unit 36 and pinion gear 34. The electromagnetic clutch 38 is normally disengaged so that the reduction gear unit 36 and the electric motor 32 are not back driven when the lift-gate 12 is opened or closed manually.

Pinion gear 34 drives rotor 24 which is preferably attached to or an integral part of a sector gear 40 that has teeth that mesh with the teeth of pinion gear 34. Drive unit 22 preferably includes a position sensor 42, such as a resistive or optical sensor, to monitor the position of either the rotor 24 or the lift-gate 12 and provide feed-back to an electronic motor control 44 for electric motor 32 and electromagnetic clutch 38 if one is used. Position sensors and electronic motor controls are well known in the art and thus the position sensor 42 and the electronic motor control 44 are merely illustrated schematically and not shown nor described in detail. Position sensor 42 and electronic motor control 44 are preferably mounted inside the associated pillar 23 for each drive unit 22.

The controlled counterbalance actuator operates as follows. When the lift-gate 12 is in the open position shown in solid line in FIGS. 1 and 2, the moment arm geometry and the forces of the gas springs 26 are sufficient to hold the lift-gate 12 in the open position where the closing effects of gravity are at or near maximum. To close lift-gate 12, the electronic motor control in response to a “close” control command energizes the electromagnetic clutch 38 and the electric motor 32 of each drive unit 22 so as to index the sector gear 40 and the rotor 24 attached to it angularly in a counterclockwise direction from the home position “H” shown in solid line in FIG. 2 to the close position “C” shown in phantom in FIG. 2. As rotor 24 rotates counter-clockwise toward the close position “C”, the moment arm of the force of the gas spring 26 decreases so that when rotor 24 reaches the close position “C”, the weight of the lift-gate 12 is sufficient to overcome the total counterbalance forces of the gas springs 26 of all drive units 22 causing the lift-gate 12 to rotate clockwise toward the closed position shown in FIG. 3. The sensor 42 indicates to the electronic motor control 44, the speed, direction and the position of the lift-gate as it approaches the closed position shown in FIG. 3. This feedback to the electronic motor control 44 energizes the electromagnetic clutch 38 and the electric motor 32 of each drive unit 22 to index the sector gear 40 and the rotor 24 attached to it angularly in a clockwise direction to adjust the position of the rotor 24 between the close position “C” and the home position “H” preferably in such a manner to maintain a near constant speed of counter balance closing. In some instances, it may be desirable to index rotor 24 past the home position “H” toward the open position “O” shown in phantom in FIG. 3. In such instances, the rotor 24 would be returned to the home position “H” after latching and cinching of the lift-gate in the closed position is completed. It should be noted that the pivot pin 25 of gas spring 26 is preferably “over center” when the lift-gate is latched and cinched in the closed position so that the gas spring 26 of each drive unit 22 urges the lift-gate 12 toward the closed position.

To open lift-gate 12, the lift-gate is unlatched and then, the electronic motor control in response to an “open” control command energizes the electromagnetic clutch 38 and the electric motor 32 of each drive unit 22 so as to index the sector gear 40 and the rotor 24 attached to it angularly in a clockwise direction from the home position “H” shown in solid line in FIG. 3 to the open position “O” shown in phantom in FIG. 3. As rotor 24 rotates clockwise toward the open position “O”, the moment arm of the force of the gas spring 26 moves “over center” and increases so that when rotor 24 reaches the open position “O”, the counterbalance forces of the gas springs 26 of all drive units 22 are sufficient to overcome the weight of the lift-gate 12 causing the lift-gate to rotate counter-clockwise toward the open position shown in FIG. 2. The sensor 42 indicates to the electronic motor control 44, the speed, direction and the position of the lift-gate as it approaches the open position shown in FIG. 2. This feedback to the electronic motor control 44 energizes the electromagnetic clutch 38 and the electric motor 32 of each drive unit 22 to index the sector gear 40 and the rotor 24 attached to it angularly in a counter-clockwise direction to adjust the position of the rotor 24 between the open position “O” and the home position “H” preferably in such a manner to maintain a near constant speed of counter balance opening. Rotor 24 reaches the home position “H” when lift-gate 12 reaches the open position as shown in solid line in FIG. 2. Under these conditions, the total counterbalance moment of the gas springs 26 of all drive units 22 counterbalance, i.e. equal the gravity moment of the lift-gate 12 which is at or near maximum and the lift-gate 12 is held in the open position.

Sensor 42 can also be used to detect contact between the lift-gate 12 and an obstacle during opening or closure and generate a signal to the electronic motor control 44 to reverse the direction of the rotor and lift-gate.

While the controlled counterbalance actuator of the invention has been described as comprising two identical drive units, in some instances one drive unit may be sufficient although a balanced system with a drive unit at each side of the lift-gate is preferred. Moreover, the drive units need not be identical in every respect although identity or near identity is preferred from an economical stand point.

Moreover the rotors of two drive units can be driven by a single electric motor with one position sensor and one electronic motor control. In other words, many modifications and variations of the present invention in light of the above teachings may be made. It is therefore to be understood that, within the scope of the appended claims, the invention may be practical otherwise than as specifically described.

We claim:

1. A controlled counter-balance actuator for opening and closing a lift-gate of a vehicle that is hinged to the vehicle for movement about a substantially horizontal axis, the controlled counter-balance actuator comprising:
a drive unit having a rotor that is adapted to be pivotally secured to a body of the vehicle in a fixed position and a gas spring,
the gas spring being pivotally secured to the rotor at one end and adapted to be pivotally secured to the lift-gate at the opposite end,
the rotor being indexable angularly so as to rotate from a home position to a close position and from the home position to an open position,
the controlled counter-balance actuator being capable of holding the lift-gate in the open position when the rotor is in the home position, moving the lift-gate toward a closed position when the rotor is indexed from the home position to the close position, and moving the lift-gate toward an open position when the rotor is indexed from the home position to the open position.

2. The controlled counter-balance actuator as defined in claim 1 further including an electric motor to index the rotor.

3. The controlled counter-balance actuator as defined in claim 2 further including a position sensor that senses the position of the rotor to provide feed back for controlling the motor.

4. A controlled counter-balance actuator for opening and closing a lift-gate of a vehicle that is hinged to the vehicle for movement about a substantially horizontal axis, the controlled counter-balance actuator comprising:
a drive unit having a rotor that is adapted to be pivotally secured to a body of the vehicle in a fixed position and a gas spring,
the gas spring being pivotally secured to the rotor at one end and adapted to be pivotally secured to the lift-gate at the opposite end,
the rotor being indexable angularly so as to rotate from a home position to a close position in one direction and back, and from the home position to an open position in the opposite direction and back,
the controlled counter-balance actuator being capable of holding the lift-gate in the open position when the rotor is in the home position, moving the lift-gate toward a closed position when the rotor is indexed from the home position to the close position, and moving the lift-gate toward an open position when the rotor is indexed from the home position to the open position.

5. The controlled counter-balance actuator as defined in claim 4 wherein the gas spring is over center when the rotor is in the home position and the lift-gate is closed.

6. The controlled counter-balance actuator as defined in claim 4 further comprising:
a sector gear attached to the rotor,
a pinion gear meshing with the sector gear, and
an electric motor driving the pinion gear to index the rotor from the home position to the close position or from the home position to the open position.

7. The controlled counter-balance actuator as defined in claim 5 further comprising:
a sector gear attached to the rotor,
a pinion gear meshing with the sector gear, and
an electric motor driving the pinion gear to index the rotor from the home position to the close position or from the home position to the open position.
